(19) United States
(12) Patent Application Publication
(10) Pub. No.: US 2003/0099050 A1
(43) Pub. Date: May 29, 2003

(54) Apparatus and method for writing head positioning information to disk medium

(76) Inventor: Katsuyoshi Kitagawa, Akishima-shi (JP)

Correspondence Address: PILLSBURY WINTHROP, LLP, P.O. BOX 10500, MCLEAN, VA, 22102, US

(21) Appl. No.: 10/217,653

(22) Filed: Aug. 14, 2002

(30) Foreign Application Priority Data
Nov. 27, 2001 (JP) 2001-361313

(51) Int. Cl. G11B 5/86; G11B 5/09; G11B 21/02

(52) U.S. Cl. 360/15; 360/51; 360/75

(57) ABSTRACT

A controller rotates, using a spindle motor, a first disk medium and at least one second disk medium in a state in which the first and second disk mediums are stacked. In this state, the controller controls a VCM on the basis of first head positioning information read by a first head from the first disk medium. As a result, a carriage that supports the first and second heads is driven to position the first and second heads in respective target radial positions on the first and second disk mediums. The controller causes the second head to write second head positioning information to the second disk medium, while changing the target radial position in increments of a predetermined pitch.

### CROSS-REFERENCE TO RELATED APPLICATIONS

This application is based upon and claims the benefit of priority from the prior Japanese Patent Application No. 2001-361313, filed Nov. 27, 2001, the entire contents of which are incorporated herein by reference.

### BACKGROUND OF THE INVENTION

1. Field of the Invention

The present invention relates to an apparatus and method suitable for writing head positioning information to each recording surface of a disk medium for use in a disk apparatus.

2. Description of the Related Art

A hard disk drive (HDD) is known as a disk drive using a disk (disk medium) as a recording medium. In general, servo information as head positioning information is pre-written to each recording surface of a disk incorporated in a hard disk drive. In the hard disk drive, positioning control for positioning the head to a target track is executed on the basis of the servo information.

The servo information pre-written on a disk is called an embedded servo. To prepare a disk on which servo information is pre-written, i.e., an embedded-servo type disk, a servo information (head positioning information) writing apparatus called a servo track writer (STW) is necessary. The servo information writing apparatus has a spindle motor as disk medium rotating means. The spindle motor rotates a disk as a target to which servo information is to be written. As the spindle motor, an air (air bearing) spindle motor with a low degree of runout is used. The servo information writing apparatus positions the head (magnetic head) in a target position on a disk while the disk is being rotated by the spindle motor. In this state, the servo information writing apparatus writes servo information to the disk using the head. To position the head, a highly accurate scale such as a laser encoder is used.

Recent servo information writing apparatuses are configured to simultaneously write servo information to a plurality of stacked disks. This enhances the productivity of disks provided with servo information. Jpn. Pat. Appln. KOKAI Publication No. 2001-216750 discloses such a servo information writing apparatus. In the disclosed apparatus, stacked disks are rotated by a single spindle motor. Further, a plurality of heads are attached to a carriage, stacked. These heads correspond to the respective recording surfaces of the disks. The writing apparatus simultaneously positions the stacked heads in target positions on the respective recording surface of the disks, thereby writing servo information to the disks.

In the above-described conventional servo information (head positioning information) writing apparatus, the writing accuracy of servo information (head positioning information) is limited by the runout degree of the spindle motor and the head positioning accuracy of the apparatus. Accordingly, to enhance the servo information (head positioning information) writing accuracy in order to increase the density of tracks of a disk, it is necessary to increase the accuracy of the spindle motor and the accuracy of head positioning. However, the realization of a highly accurate spindle motor and highly accurate head positioning is not easy because of technical limits and high cost.

### BRIEF SUMMARY OF THE INVENTION

The present invention has been developed in light of the above circumstances, and aims to provide a head positioning information writing apparatus with its head positioning information writing accuracy enhanced without increasing the accuracy of the spindle motor or the head positioning accuracy, and a head positioning information writing method employed in the apparatus.

According to an aspect of the invention, there is provided an apparatus for writing second head positioning information to at least one recording surface of at least one second disk medium in a state in which the at least one second disk medium and a first disk medium having first and second surfaces are stacked, first head positioning information being pre-recorded on the first surface. This apparatus comprises, as well as the first disk medium, rotating means, first and second heads, supporting means, driving means, controlling means and head positioning information generator. The rotating means rotates the first disk medium and the at least one second disk medium in a state in which the first and second disk mediums are stacked. The first head is located corresponding to the first surface of the first disk medium, and reads the first head positioning information recorded on the first surface. The second head is located corresponding to the at least one recording surface of the at least one second disk medium, and writes the second head positioning information to the at least one recording surface of the at least one second disk medium. The supporting means supports the first and second heads such that the first and second heads can simultaneously move in a radial direction of the first and second disk mediums. The driving means drives the head support means. The controlling means controls the head driving means on a basis of the first head positioning information read by the first head, thereby positioning the first head in a target radial position on the first disk medium. In this state, the controlling means causes the second head to write, to the at least one second disk medium, the second head positioning information by an amount corresponding to one rotation of the at least one second disk medium. The controlling means shifts the target radial position by a predetermined pitch each time the second head positioning information has been written by the amount corresponding to one rotation of the at least one second disk medium.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

### BRIEF DESCRIPTION OF THE SEVERAL VIEWS OF THE DRAWING

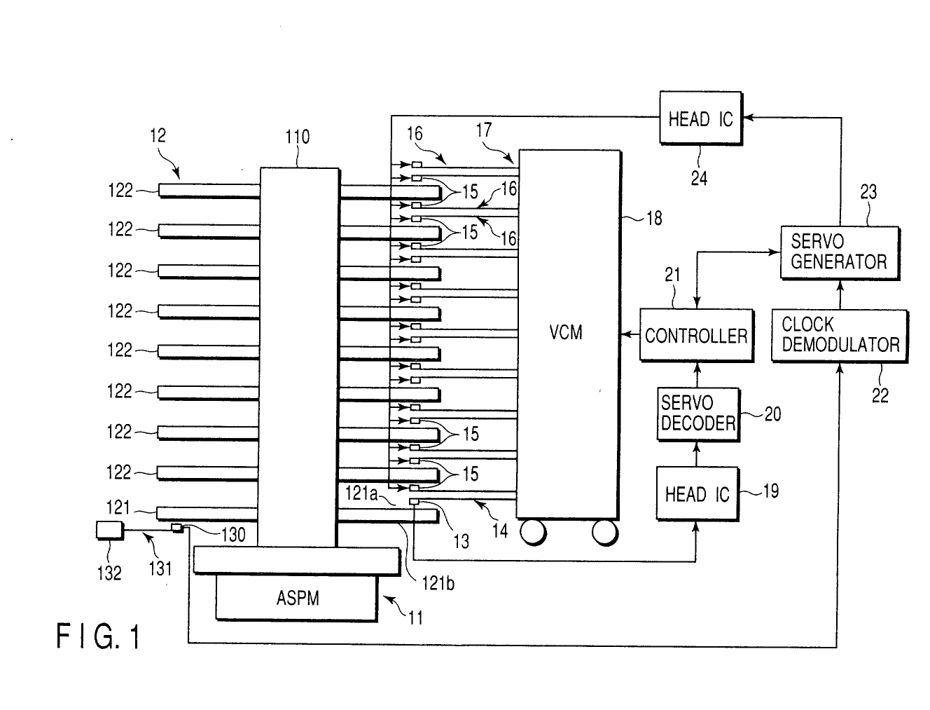

FIG. 1 is a block diagram illustrating the basic structure of a servo information writing apparatus according to an embodiment of the invention;

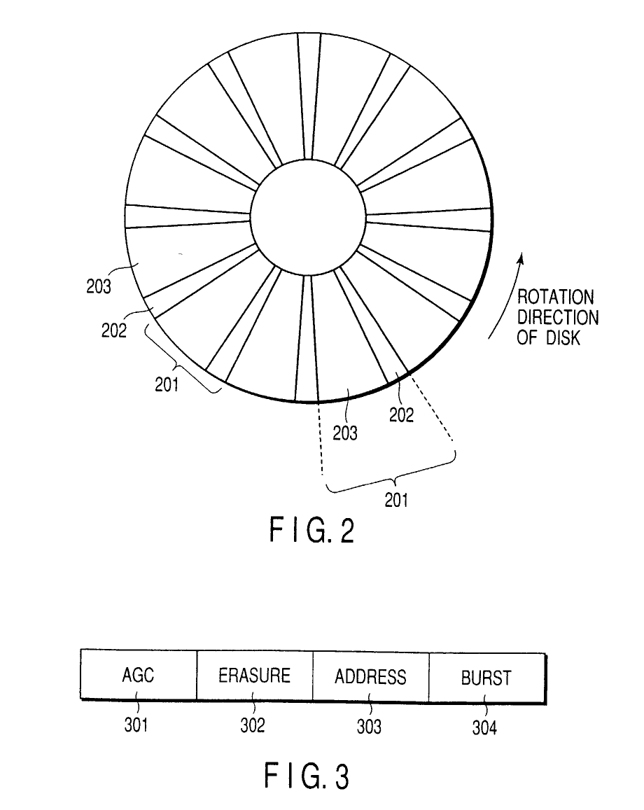

FIG. 2 is a view illustrating an example of a format formed on a magnetic disk by writing servo information thereto using the servo information writing apparatus of FIG. 1;

FIG. 3 is a view illustrating an example of a servo information format;

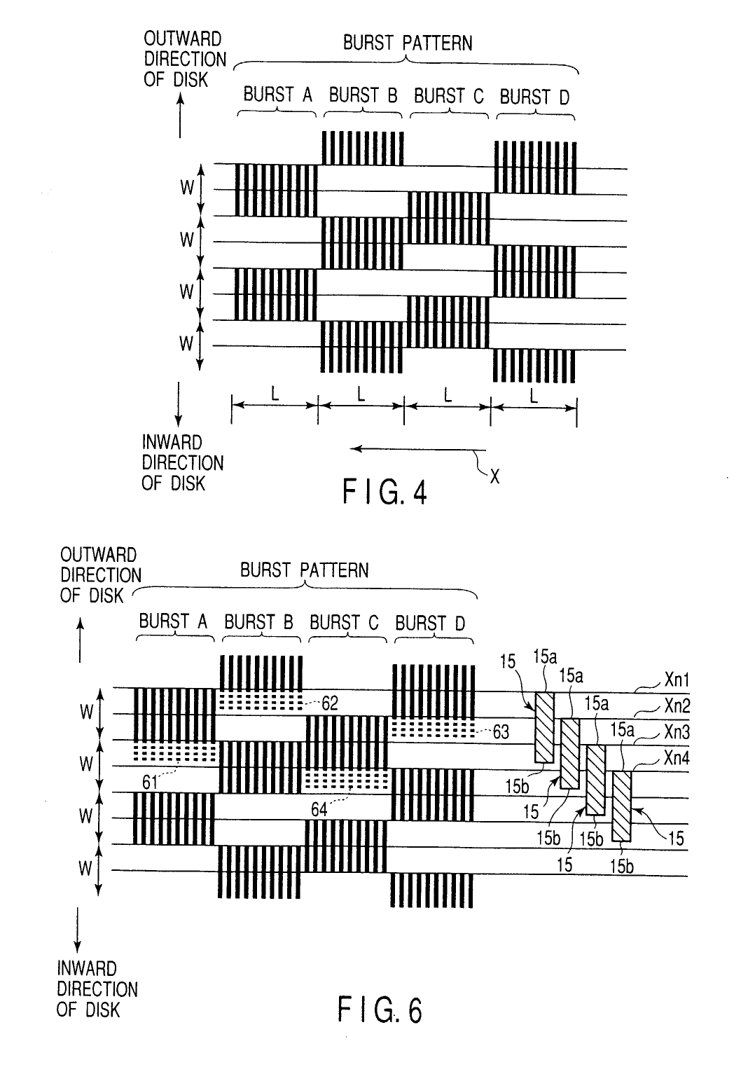

FIG. 4 is a view illustrating a recorded example of a burst pattern included in the servo information;

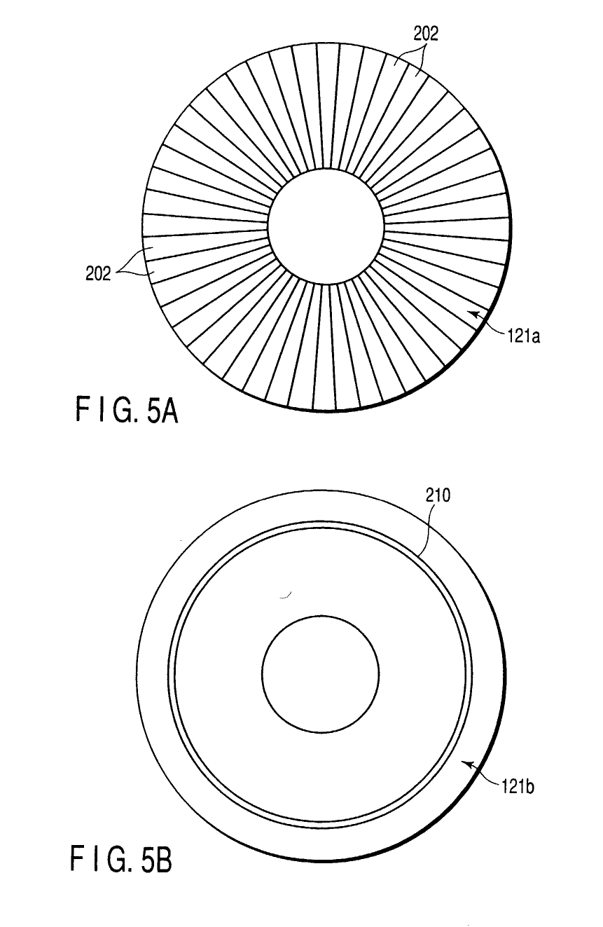

FIG. 5A is a view illustrating an example of a format formed on the master servo surface 121a of a master disk 121 appearing in FIG. 1;

FIG. 5B is a view illustrating an example of a format formed on the clock surface 121b of the master disk 121;

FIG. 6 is a view useful in explaining the writing of the burst pattern in the embodiment;

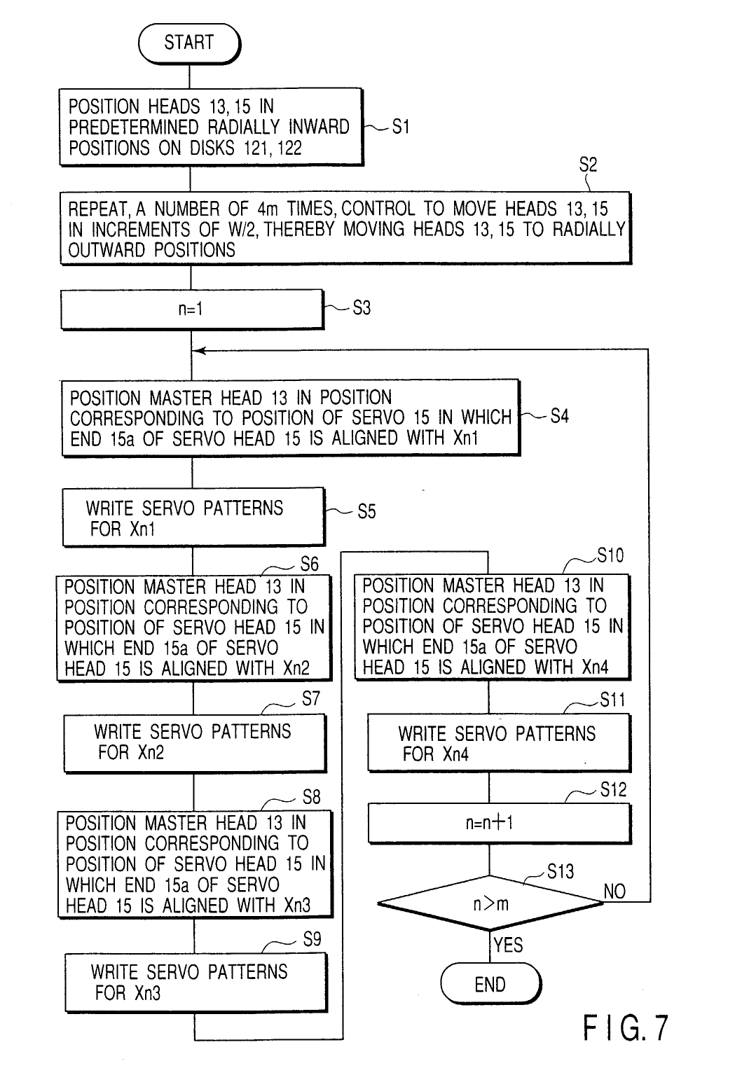

FIG. 7 is a flowchart useful in explaining the procedure of writing servo information in the embodiment;

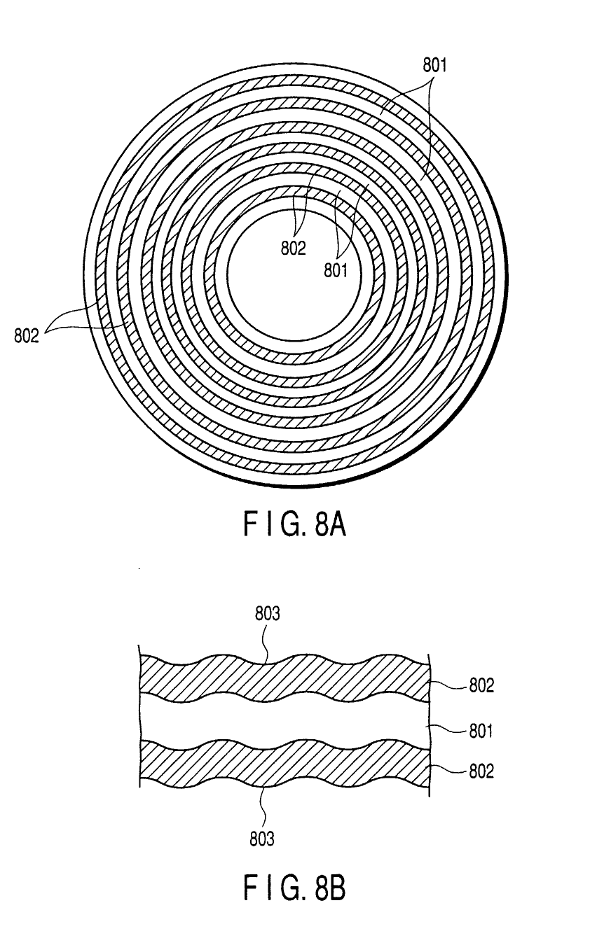

FIG. 8A is a view illustrating an example of a format formed on an optical disk used as the master disk 121 in a modification of the embodiment; and

FIG. 8B is a view illustrating a state in which wobble 803 is formed at land and groove tracks 801 and 802 appearing in FIG. 8A.

### DETAILED DESCRIPTION OF THE INVENTION

An embodiment of the invention will be described with reference to the accompanying drawings. FIG. 1 is a block diagram illustrating the basic structure of a servo information writing apparatus (hereinafter referred to as a “servo track writer”) according to the embodiment of the invention. In FIG. 1, a spindle motor 11, e.g., an air spindle motor (ASPM), has a cylindrical hub 110 serving as a rotor. A magnetic disk stack 12 is dismountably mounted on the hub 110 of the spindle motor 11. The magnetic disk stack 12 includes a single master disk 121. The master disk 121 is a magnetic disk, which is referred to when servo information as head positioning information is written to another magnetic disk. The magnetic disk stack 12 also includes at least one magnetic disk other than the master disk, e.g., a plurality of magnetic disks 122. Each magnetic disk 122 is a target to which the servo track writer writes servo information. The master disk 121 and each magnetic disk 122 are vertically stacked at regular intervals. In this embodiment, the master disk 121 is located at the lowest portion of the magnetic disk stack 12. When the servo track writer writes servo information, the magnetic disk stack 12 is mounted on the hub 110 of the spindle motor 11. After the writing of servo information has finished, the magnetic disk stack 12 is dismounted from the hub 110. In this embodiment, the master disk 121 is located at the lowest part of the magnetic disk stack 12, however, it may be permanently mounted on the hub 110 of the air spindle motor.

A description will now be given of the format of a standard magnetic disk incorporated in the hard disk drive. This magnetic disk has two surfaces. One or both of the two surfaces of the magnetic disk (both in this embodiment) are used as recording surfaces on which data is recorded. As shown in FIG. 2, each recording surface of the magnetic disk is circumferentially divided into sectors (servo sectors) 201 at regular intervals. Each sector 201 comprises a servo area 202 with servo information written thereon, and a data area 203 to which data is to be written. As shown in FIG. 3, each servo information item comprises an AGC section 301, erase section 302, address section 303 and burst section 304. The AGC section 301 contains a signal of a predetermined frequency, which is used to adjust the gain of a read amplifier for amplifying a signal (read signal) read from the magnetic disk by a corresponding head. This gain adjustment adjusts the amplitude of the read signal to a constant value. The erase section 302 contains a particular pattern signal called a “servo mark”. The servo mark is used to detect (recognize) (the servo area 202 in) a corresponding sector 201. The address section 303 contains a coded address (cylinder address) assigned to a cylinder at which the head is positioned. The burst section 304 contains a burst pattern (servo burst pattern) that indicates, in the form of a waveform amplitude, the position of the head relative to the cylinder indicated by the cylinder address in the address section 303 (i.e., a position error).

FIG. 4 is a view illustrating an example of a burst pattern recorded on a disk. As shown, the burst pattern comprises 4-phase burst signals (hereinafter referred to simply as a “burst”) A, B, C and D. The bursts C and D are recorded at positions shifted in phase by 90° from the bursts A and B, respectively. In other words, the burst pattern is formed of a pair of bursts A and B and a pair of bursts C and D, which are shifted in phase by 90°. In the example of FIG. 4, the upper portion is the radially outward portion of the disk, wile the lower portion is the radially inward portion of the disk. Further, the disk rotates from right to left as indicated by the arrow X. The bursts A, B, C and D have the same recording width W in the radial direction of the disk (i.e., in the vertical direction in FIG. 4). Further, the bursts A, B, C and D have the same recording length L in the circumferential direction of the disk (in the side-to-side direction in FIG. 4). After the servo information has been written to each magnetic disk 122 of the magnetic disk stack 12 in FIG. 1, the disk formats are identical to that shown in FIGS. 2-4.

The format of the master disk 121 will now be described. The master disk 121 has two surfaces. One, for example, the upper surface, serves as a recording surface (hereinafter referred to as a “master servo surface”) 121a. The servo information written on the master servo surface 121a is called “master servo information”. The format of the master servo information is the same as that of the servo information written on each standard magnetic disk in the hard disk drive, i.e., that shown in FIG. 2. However, on the master servo surface 121a of the master disk 121, servo areas 202 of the same shape and size are provided in a radial pattern along the entire circumference of the disk, with no gap therebetween, as is shown in FIG. 5A. This differs from the recording surfaces of standard magnetic disks. Thus, in the embodiment, the sampling frequency of servo information is increased by increasing the number of servo areas 202 provided on the master servo surface 121a of the master disk 121. On the other hand, the lower surface of the master disk 121 serves as a recording surface (hereinafter referred to as a “clock surface”) 121b on which a clock track 210 is formed, as is shown in FIG. 5B. A clock pattern is prewritten on the clock track 210.

Referring again to FIG. 1, a head assembly 14 is provided at a position corresponding to the master servo surface (upper surface) 121a of the master disk 121 included in the magnetic disk stack 12. The head assembly 14 includes a head (hereinafter referred to as a “master head”) 13. Further, a head (hereinafter referred to as a “clock head”) 130 is provided at a predetermined position corresponding to the clock track 210 (see FIG. 5B) on the clock surface (lower surface) 121b of the master disk 121. The clock head 130 is used to read (reproduce) the clock pattern recorded on the clock track 210. A head assembly 131 including the clock head 130 is held by a holding mechanism 132.

A head assembly 16 is provided at a position corresponding to each recording surface of each magnetic disk 122 in the magnetic disk stack 12. Each head assembly 16 includes a head (hereinafter referred to as a “servo write head”) 15 that is used to write servo information to the recording surface of a corresponding magnetic disk 122. The head disk assembly incorporated in the hard disk drive is abbreviated as “HDA”. Suppose that the HDA includes at least one magnetic disk 122 to which the servo track writer of FIG. 1 has written servo information. Further, suppose that the embodiment uses, as the master head 13 and servo write head 15, heads (magnetic heads) of the same type as used in the hard disk drive which incorporates the HDA. In this case, the master head 13 and servo write head 15 have the same size.

A carriage 17 supports the head 13 and heads 15. The carriage 17 includes a head stack assembly (HSA) formed of the head assembly (HA) 14 and head assemblies (HA) 16 stacked. The carriage 17 is driven by a VCM 18 to thereby simultaneously and radially move the head 13 and heads 15 over the disk 121 and disks 122, respectively. The master head 13 is connected to a head IC (Integrated Circuit) 19. The head IC 19 has a read amplifier for amplifying a read signal read by the head 13. The head IC 19 is connected to a servo decoder 20. The servo decoder 20 detects servo information from a read signal amplified by the head IC 19, thereby extracting a burst pattern (the bursts A, B, C and D) in the servo information. This burst pattern is used as positional error information indicative of the relative positional difference between the master head 13 and master disk 121. The servo decoder 20 is connected to a controller 21. The controller 21 controls the VCM 18 (for example, in a feedback manner) on the basis of positional error information extracted by the servo decoder 20, thereby driving the carriage 17. As a result, the controller 21 simultaneously positions the head 13 and heads 15 in target radial positions on the disk 121 and disks 122 stacked in the magnetic disk stack 12.

The clock head 130 is connected to a clock demodulator 22. The clock demodulator 22 amplifies a clock pattern signal read from the clock track 210 of the master disk 121. The clock demodulator 22 also demodulates a clock signal of a predetermined cycle from the amplified clock pattern signal. The clock demodulator 22 is connected to a servo generator 23. The servo generator 23 generates a servo pattern signal (servo information) in synchronism with the clock signal output form the clock demodulator 22. This servo pattern signal corresponds to the radial positions of the head 13 and heads 15 positioned on the respective disks under the control of the controller 21. The servo generator 23 is connected to a head IC 24. The head IC 24 has a write amplifier for converting, into a write current, a servo pattern signal generated by the servo generator 23, and simultaneously supplying it to the servo write heads 15.

Referring then to FIG. 6 and the flowchart of FIG. 7, a description will be given of the operation, by the servo track writer, of writing servo information to each magnetic disk 122. Firstly, the air spindle motor (ASPM) 11 of the servo track writer is rotated at a predetermined rotational speed, e.g., 4200 rpm. The rotation of the spindle motor 11 is realized by controlling a spindle motor driver (not shown) so as to supply a current to the spindle motor 11. In this state, the master head 13 reads the master servo information pre-recorded in a radial position on the master servo surface 121a of the master disk 121, in which the master head 13 is currently positioned.

The master servo information read by the master head 13 from the master servo surface 121a of the master disk 121 is amplified by the head IC 19 and then input to the servo decoder 20. The servo decoder 20 extracts the bursts A, B, C and D of a burst pattern from the master servo information (servo pattern signal) amplified by the head IC 19, thereby supplying them to the controller 21. Upon receiving the bursts A, B, C and D extracted by the servo decoder 20, the controller 21 calculates the control variable for controlling the VCM 18. On the basis of the calculated control variable, the controller 21 executes feedback control on the VCM 18, thereby driving the carriage 17. As a result, the controller 21 positions the heads 13 and 15 in respective target radial positions on the disks 121 and 122.

As shown in FIG. 6, the heads (servo write heads) 15 each have an end 15a closer to the outer periphery of a disk, and an end 15b closer to the inner periphery of the disk. The length of each head 15 (head length), i.e., the length between the ends 15a and 15b of each head 15, is greater than the recording width W of each burst A, B, C or D as shown in FIG. 6. In this embodiment, the servo areas 202 are provided in a radial pattern on the entire master servo surface 121a of the master disk 121 with no gap therebetween, as is shown in FIG. 5A. Accordingly, servo information items are recorded in a radial pattern on the entire master servo surface 121a of the master disk 121 with no gap therebetween. On the other hand, in the standard disk incorporated in the HDD, the servo areas 202 are circumferentially dispersedly arranged as shown in FIG. 2. The circumferential width of each servo area 202 on the master disk 121 is equal to that of each servo area 202 on the usual disk. Accordingly, the number of servo areas 202 on the master disk 121 is greater than that on the usual disk. This means that the use of the master disk 121 can increase the detection frequency of servo information (servo sampling frequency). As a result, the frequency band, in which variations in the relative positions of the head 13 and disk 121 and in those of the heads 15 and disks 122 can be followed, can be widened, whereby the head positioning control accuracy (servo control accuracy) can be enhanced. Such variations occur due to the runout of the axis of the spindle motor 11. On the master servo surface 121a of the master disk 121, the servo areas 202 may be arranged circumferentially dispersed at regular intervals as are those on the usual disk shown in FIG. 2. In this case, it is necessary to arrange the servo areas 202 with intervals shorter than in the case of the usual disk. This is because it is necessary to increase the number of servo areas 202 as compared to that on the standard disk. Needless to say, the number of servo areas 202 can be further increased if they are arranged on the master disk 121 with no gap therebetween as shown in FIG. 5A.

When writing servo information to each magnetic disk 122 of the magnetic disk stack 12, the controller 21 supplies a current to the VCM 18 to drive the carriage 17. By driving the carriage 17, the controller 21 radially inwardly moves the heads 13 and 15 to respective predetermined positions (radial positions) on the disks 121 and 122 (step S1). The servo track writer shown in FIG. 1 has an inner peripheral stopper (not shown) for limiting the operation of the carriage 17. This inner peripheral stopper is used to prevent the heads 13 and 15 from jumping out of the inner peripheries of the disks 121 and 122 and colliding with the air spindle motor 11. To this end, the inner peripheral stopper is located in a position in which the predetermined portion of the carriage 17 touches the stopper when the heads 13 and 15 have been moved to the aforementioned respective predetermined positions on the disks 121 and 122. By virtue of the inner peripheral stopper, the controller 21 can position the heads 13 and 15 in the aforementioned respective predetermined positions on the disks 121 and 122.

After that, the controller 21 controls the carriage 17 via the VCM 18 so as to radially outwardly move the heads 13 and 15 in increments of a predetermined pitch, e.g., W/2, on the disks 121 and 122. The movement control in increments of W/2 is executed in the following manner. Firstly, the servo information recorded on the master servo surface 121a of the master disk 121 is read by the master head 13. Upon detecting the servo information read by the master head 13, the servo decoder 20 extracts a burst pattern from the servo information. From the burst pattern extracted by the servo decoder 20, the controller 21 calculates the relative positional errors between the master head 13 and master disk 121, and between each servo write head 15 and a corresponding magnetic disk 121. On the basis of the calculated positional errors, the controller 21 moves the heads in increments of W/2. The controller 21 repeats this head movement control 4 m (m is a natural number higher than 0) times, thereby positioning the heads 13 and 15 in respective predetermined radially outward positions (radial positions) on the disks 121 and 122 (step S2).

Subsequently, the controller 21 sets a variable n to an initial value of 1 (step S3). The variable n is a counter value indicative of the number of operations of writing servo information. Thereafter, the controller 21 positions the master head 13 in a position corresponding to the position of each servo write head 15 in which the end 15a of each servo write head 15 closer to the outer periphery of the disk is aligned with a predetermined radially outward position Xn1 (n=1) on a recording surface of a corresponding magnetic disk 122 (step S4). In this state, the controller 21 causes the servo generator 23 to generate servo patterns corresponding to the position Xn1 (n=1) in synchronism with a clock signal demodulated by the clock demodulator 22. Then, the controller 21 causes each servo write head 15 to dispersedly write the servo patterns corresponding to Xn1 (n=1) to an area on the recording surface of a corresponding magnetic disk 122, the area being covered by the head 15 during one rotation of the disk 122 (step S5). The writing of the servo patterns at the step S5 is executed for the period for which each magnetic disk 122 executes one rotation. As a result of this writing, servo patterns are written to the dispersed areas that form parts of the servo areas 202 and are included in the area of the recording surface of the corresponding magnetic disk corresponding to one rotation of the disk and also corresponding to the position of the servo write head 15. More particulars concerning the writing of the servo patterns corresponding to Xn1 (n=1) will be described later.

Thereafter, the controller 21 positions the master head 13 in a position that is radially inward, by a predetermined pitch, e.g. W/2, from the present positions of the master head 13 and each servo write head 15 (step S6). The radial position of the master head 13 assumed after the movement of W/2 corresponds to the radial position to which the end 15a of the servo write head 15 is radially inwardly moved by W/2, i.e., a radial position Xn2 (n=1). In this state, the controller 21 causes the servo generator 23 to generate servo patterns corresponding to Xn2 (n=1) in synchronism with the clock signal demodulated by the clock demodulator 22. After that, for the period for which each magnetic disk 122 executes one rotation, the controller 21 causes each servo write head 15 to dispersedly write the servo patterns corresponding to Xn2 (n=1) to the area on the recording surface of a corresponding magnetic disk 122, which corresponds to the one rotation of the disk (step S7). More particulars concerning the writing of the servo patterns corresponding to Xn2 (n=1) will also be described later.

Thereafter, the controller 21 positions the master head 13 in a position that is radially inward, by a predetermined pitch, e.g. W/2, from the present positions of the master head 13 and each servo write head 15 (step S8). The radial position of the master head 13 assumed after the movement of W/2 corresponds to the radial position to which the end 15a of the servo write head 15 is radially inwardly moved by W/2, i.e., a radial position Xn3 (n=1). In this state, the controller 21 causes the servo generator 23 to generate servo patterns corresponding to Xn3 (n=1) in synchronism with the clock signal demodulated by the clock demodulator 22. After that, for the period for which each magnetic disk 122 executes one rotation, the controller 21 causes each servo write head 15 to dispersedly write the servo patterns corresponding to Xn3 (n=1) to the area on the recording surface of a corresponding magnetic disk 122, which corresponds to the one rotation of the disk (step S9). More particulars concerning the writing of the servo patterns corresponding to Xn3 (n=1) will also be described later.

After that, the controller 21 positions the master head 13 in a position that is radially inward, by a predetermined pitch, e.g. W/2, from the present positions of the master head 13 and each servo write head 15 (step S10). The radial position of the master head 13 assumed after the movement of W/2 corresponds to the radial position to which the end 15a of the servo write head 15 is radially inwardly moved by W/2, i.e., a radial position Xn4 (n=1). In this state, the controller 21 causes the servo generator 23 to generate servo patterns corresponding to Xn4 (n=1) in synchronism with the clock signal demodulated by the clock demodulator 22. After that, for the period for which each magnetic disk 122 executes one rotation, the controller 21 causes each servo write head 15 to dispersedly write the servo patterns corresponding to Xn4 (n=1) to the area on the recording surface of a corresponding magnetic disk 122, which corresponds to the one rotation of the disk (step Sl8). More particulars concerning the writing of the servo patterns corresponding to Xn4 (n=1) will also be described later.

After executing writing of the servo patterns corresponding to Xn1, Xn2, Xn3 and Xn4, the controller 21 increments the variable (counter value indicative of the number of occasions of writing) n by 1 (step S12). Then, the controller 21 determines whether or not the incremented variable n exceeds a predetermined threshold value m (step S13). If the incremented variable n does not exceed the predetermined threshold value m, the controller 21 determines that servo writing has not been finished. In this case, the controller 21 re-executes the step S4 et seq., using the incremented variable n. On the other hand, if the incremented variable n exceeds the predetermined threshold value m, the controller 21 determines that servo writing has been finished. At this time, the respective servo patterns are written on the portions of the recording surfaces of each magnetic disk 122 corresponding to X11, X12, X13, X14—Xm1, Xm2, Xm3, Xm4.

The servo patterns (servo information) corresponding to Xn1, Xn2, Xn3 or Xn4 contain different burst patterns. Referring to FIG. 6, a description will be given of the writing of a burst pattern corresponding to each of Xn1, Xn2, Xn3 and Xn4. Firstly, the end 15a of each servo write head 15 is positioned in the radial position Xn1. In this state, the burst A is written to a burst section for it in accordance with the rotation of a magnetic disk 122 corresponding to each head 15. Since the head length of each servo write head 15 is greater than W, the radially inward edge portion 61 of the burst A corresponding to the difference between the head length and W radially inwardly projects from the position Xn3. However, the edge portion 61 is erased when a burst pattern corresponding to Xn3 is written, as will be described later. In the next burst section for the burst B, the edge portion 62 of the burst B written when a burst pattern corresponding to X(n−1)3 has been written is erased by a DC (direct current) signal. Nothing is written to the next burst sections for the bursts C and D. The writing of these bursts is intermittently executed in synchronism with the clock signal demodulated by the clock demodulator 22 during one rotation of each magnetic disk 122.

Subsequently, the master head 13 and servo write heads 15 are radially inwardly moved by W/2, thereby positioning the end 15a of each servo write head 15 in the radial position Xn2. At this time, nothing is written to burst sections for the bursts A and B. However, the next burst C is written to a burst section for it. In the next burst section for the burst D, the edge portion 63 of the burst D written when a burst pattern corresponding to X(n−1)4 has been written is erased by a DC signal. The writing of these bursts is intermittently executed in synchronism with the clock signal demodulated by the clock demodulator 22 during one rotation of each magnetic disk 122.

After that, the master head 13 and servo write heads 15 are radially inwardly moved by W/2, thereby positioning the end 15a of each servo write head 15 in the radial position Xn3. In a burst section for the burst A, the edge portion 61 of the burst A written when a burst pattern corresponding to X(n−1)1 has been written is erased by a DC signal. The burst B is written to the next burst section for it. To the next burst sections for the bursts C and D, nothing is written. The writing of these bursts is intermittently executed during one rotation of each magnetic disk 122.

Thereafter, the master head 13 and servo write heads 15 are radially inwardly moved by W/2, thereby positioning the end 15a of each servo write head 15 in the radial position Xn4. Firstly, nothing is written to burst sections for the bursts A and B. In the next burst section for the burst C, the edge portion 64 of the burst C written when a burst pattern corresponding to Xn2 has been written is erased by a DC signal. The burst D is written to the next burst section for it. The writing of these bursts is intermittently executed during one rotation of each magnetic disk 122.

In the servo writer employed in the embodiment, the master disk 121 recording servo information and master head 13 are joined to construct a sensor (head position detecting sensor) for detecting the position of each servo write head 15. As is evident, position information extracted from servo information, which is read by the master head 13 from the master disk 121, indicates the relative positions of each magnetic disk 122 and a corresponding servo write head 15. In other words, in the embodiment, the relative positions of each magnetic disk 122 and a corresponding servo write head 15 is detected, using the servo information on the master disk 121 and the master head 13. This enables the control system (feedback control system) including the controller 21 to follow the runout of the air spindle motor 11 if the runout falls within the range of the head positioning control zone. Accordingly, the embodiment can enhance the accuracy of writing servo information without enhancing the accuracy of the air spindle motor 11. In general, the higher the density of tracks on a magnetic disk, the higher the sensitivity of the head (magnetic head). Therefore, the head position detecting accuracy of the head position detecting sensor constructed as above can be enhanced by using a head and magnetic disk corresponding to the generation of the hard disk drive.

In the embodiment, the format of the servo information recorded on the master disk 121 is identical to that of the servo information written by the servo track writer shown in FIG. 1. However, as the servo information recorded on the master disk 121, servo information can be used, which contains only the AGC section 301, erase section 302 and burst section 304 and no address section 303. In this case, the number of servo areas 202 on the master disk 121 can be further increased to thereby further enhance the servo information sampling frequency.

As described above, the master head 13 and servo write heads 15 are of the same type as the heads for use in a hard disk drive that incorporates the HDA. However, it is not always necessary to use master and servo write heads of the same type. Further, it is not always necessary to use a master head of the same type as a head used in a hard disk drive incorporating the HDA.

Modification of the Embodiment

In the above-described embodiment, the accuracy of writing servo information to each magnetic disk 122 is determined on the basis of the accuracy of the servo information recorded on the master disk 121. To enhance the accuracy of the servo information on the master disk 121, a highly accurate servo track writer that is obtained by improving the conventional servo track writers is necessary to generate highly accurate servo information. Referring again to FIG. 1 for convenience sake, a description will now be given of a modification of the embodiment, which can easily produce a master disk 121 with highly accurate servo information, without using such a highly accurate servo track writer.

This modification is characterized in that an optical disk is used as the master disk 121 instead of a magnetic disk, unlike the embodiment. Accordingly, an optical head (optical pickup) is used, instead of a magnetic head, as the master head 13 that forms a head position detecting sensor. On a recording surface of the optical disk used as the master disk 121, concentric land tracks 801 and groove tracks 802 as tracking information are arranged alternately, as is shown in FIG. 8A. It should be noted that the land and groove tracks 801 and 802 are not spiral, which differs from a standard optical disk.

The land and groove tracks 801 and 802 are arranged with a pitch of W/2 so as to enable head drive control (head forwarding) to be executed in increments of W/2N (N: a natural number higher than 0). At the present technical level, optical disks have a higher recording density than magnetic disks. Therefore, if N is set to, for example, 2, the pitch of the land and groove tracks 801 and 802 is reduced to W/4, whereby the accuracy of the tracking information can be made higher than in the case of using a magnetic disk. The increase in the accuracy of the tracking information can enhance the head positioning control accuracy. Further, the land and groove tracks 801 and 802 may be formed to have wobble as shown in FIG. 8B. In this case, from the wobble 803 detected by the master head (optical head) 13, a clock demodulator corresponding to the clock demodulator 22 can demodulate a wobble clock signal. This makes, unnecessary, an optical head corresponding to the clock head 130, and a track corresponding to the clock track 210.

In addition, in the embodiment, the invention is applied to a servo track writer (servo information writing apparatus) for writing servo information to a magnetic disk for use in a hard disk drive (HDD). However, the invention is also applicable to a servo track writer for writing servo information to a disk medium, such as a magneto-optical disk, other than a magnetic disk.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for writing head positioning information comprising:
a first disk medium having first and second surfaces, first head positioning information being pre-recorded on the first surface;
means for rotating the first disk medium and at least one second disk medium having at least one recording surface and stacked thereon;
a first head located corresponding to the first surface of the first disk medium, the first head reading the first head positioning information recorded on the first surface;
a second head located corresponding to the at least one recording surface of the at least one second disk medium, the second head writing second head positioning information to the at least one recording surface;
means for supporting the first and second heads such that the first and second heads can simultaneously move in a radial direction of the first and second disk mediums;
means for driving the supporting means; and
means for controlling the driving means on a basis of the first head positioning information read by the first head, thereby positioning the first head in a target radial position on the first disk medium, and causing the second head to write, to the at least one second disk medium, the second head positioning information by an amount corresponding to one rotation of the at least one second disk medium, the controlling means shifting the target radial position by a predetermined pitch each time the second head positioning information has been written by the amount corresponding to one rotation of the at least one second disk medium.

2. An apparatus according to claim 1, wherein the first head positioning information is recorded in a radial pattern with no gap on the entire first surface of the first disk medium.

3. An apparatus according to claim 1, wherein the first head positioning information is dispersedly recorded in a radial pattern at regular intervals on the entire first surface of the first disk medium, the intervals each being shorter than each of intervals at which the second head positioning information is written to the at least one second disk medium.

4. An apparatus according to claim 1, further comprising a head positioning information generator configured to generate the second head positioning information to be written to the at least one second disk medium by the second head, with the first head positioned in the target radial position on the first disk medium.

5. An apparatus for writing servo information comprising:
a first disk medium having first and second surfaces, first servo information being pre-recorded on the first surface;
a spindle motor rotating the first disk medium and at least one second disk medium having at least one recording surface and stacked thereon;
a first head located corresponding to the first surface of the first disk medium, the first head reading the first servo information recorded on the first surface;
a second head located corresponding to the at least one recording surface of the at least one second disk medium, the second head writing second servo information to the at least one recording surface;
a carriage supporting the first and second heads such that the first and second heads can simultaneously move in a radial direction of the first and second disk mediums;
a voice coil motor driving the carriage; and
a controller controlling the voice coil motor on a basis of the first servo information read by the first head, thereby positioning the first head in a target radial position on the first disk medium, and causing the second head to write, to the at least one second disk medium, the second servo information by an amount corresponding to one rotation of the at least one second disk medium, the controller shifting the target radial position by a predetermined pitch each time the second servo information has been written by the amount corresponding to one rotation of the at least one second disk medium.

6. An apparatus according to claim 5, wherein the first servo information is recorded in a radial pattern with no gap on the entire first surface of the first disk medium.

7. An apparatus according to claim 5, wherein the first servo information is dispersedly recorded in a radial pattern at regular intervals on the entire first surface of the first disk medium, the intervals each being shorter than each of intervals at which the second servo information is written to the at least one second disk medium.

8. An apparatus according to claim 5, further comprising a servo generator configured to generate the second servo information to be written to the at least one second disk medium by the second head, with the first head positioned in the target radial position on the first disk medium.

9. An apparatus according to claim 8, wherein each of the first and second disk mediums is a magnetic disk medium, and each of the first and second heads is a magnetic head.

10. An apparatus according to claim 9, wherein:
a clock track with a magnetic clock pattern pre-recorded thereon is formed in a predetermined radial position on the second surface of the first disk medium, the clock pattern being used to demodulate a clock signal, and further comprising:
a third head reading the clock pattern from the clock track on the first disk medium; and
a clock demodulator configured to demodulate the clock signal from the clock pattern read by the third head, the servo generator generating the second servo information in synchronism with the clock signal demodulated by the clock demodulator.

11. An apparatus for writing servo information comprising:
an optical disk medium having first and second surfaces, tracking information being pre-recorded on the first surface;
at least one magnetic disk medium having at least one recording surface;
a spindle motor rotating the optical disk medium and the at least one magnetic disk medium stacked thereon;
an optical head located corresponding to the first surface of the optical disk medium, the optical head reading the tracking information recorded on the first surface;
a magnetic head located corresponding to the at least one recording surface of the at least one magnetic disk medium, the magnetic head writing servo information to the at least one recording surface;
a carriage supporting the optical and magnetic heads such that the optical and magnetic heads can simultaneously move in a radial direction of the optical and magnetic disk mediums;
a voice coil motor driving the carriage; and
a controller controlling the voice coil motor on a basis of the tracking information read by the optical head, thereby positioning the optical head in a target radial position on the optical disk medium, and causing the magnetic head to write, to the at least one magnetic disk medium, the servo information by an amount corresponding to one rotation of the at least one magnetic disk medium, the controller shifting the target radial position by a predetermined pitch each time the servo information has been written by the amount corresponding to one rotation of the at least one magnetic disk medium.

12. An apparatus according to claim 11, further comprising a servo generator configured to generate the servo information to be written to the at least one magnetic disk medium by the magnetic head, with the optical head positioned in the target radial position on the optical disk medium.

13. An apparatus according to claim 11, wherein concentric land tracks and groove tracks used for reproduction of the tracking information are alternately arranged on the first surface of the optical disk medium.

14. An apparatus according to claim 13, wherein the land tracks and groove tracks are arranged with a pitch set to 1/N (N is a natural number higher than 0) of the predetermined pitch.

15. An apparatus according to claim 11, wherein:
concentric land tracks and groove tracks used for reproduction of the tracking information are alternately arranged on the first surface of the optical disk medium;
wobble, from which a clock signal is reproduced, is formed at the land and groove tracks; and
the servo generator generates the servo information in synchronism with the clock signal reproduced from the wobble.

16. A method for writing second head positioning information to at least one recording surface of at least one second disk medium stacked with a first disk medium having first and second surfaces, the first surface of the first disk medium recording first head positioning information, comprising:
driving a carriage on the basis of the first head positioning information read from the first surface of the first disk medium by a first head located corresponding to the first surface, while rotating the first and second disk mediums, thereby positioning, in respective radial positions on the first and second disk mediums, the first head and a second head located corresponding to the at least one recording surface of the at least one second disk medium, the carriage supporting the first and second heads such that the first and second heads can be simultaneously radially moved over the first and second disk mediums;
sequentially repeating control for positioning the first and second heads in respective target radial positions on the first and second disk mediums, the target radial positions being shifted in increments of a predetermined pitch each time the control has been executed; and
causing the second head to write the second head positioning information to the at least one second disk medium, while maintaining the first and second heads in the respective target radial positions on the first and second disk mediums.

17. A method according to claim 16, wherein the first head positioning information is recorded in a radial pattern with no gap on the entire first surface of the first disk medium.

18. A method according to claim 16, wherein the first head positioning information is dispersedly recorded in a radial pattern at regular intervals on the entire first surface of the first disk medium, the intervals each being shorter than each of intervals at which the second head positioning information is written to the at least one second disk medium.
